(19) United States
(12) Patent Application Publication
(10) Pub. No.: US 2007/0036608 A1
(43) Pub. Date: Feb. 15, 2007

(54) Promotional writing instrument having objects within fluid-filled chambers

(75) Inventors: Brenda S. Jones, Raleigh, NC (US); Robert A. Jones, Raleigh, NC (US); J. Daniel Chando, Raleigh, NC (US); Meghan Elizabeth Cavan, Raleigh, NC (US)

Correspondence Address: MYERS BIGEL SIBLEY & SAJOVEC, PO BOX 37428, RALEIGH, NC, 27627, US

(73) Assignee: Adstracts, Inc.

(21) Appl. No.: 11/200,220

(22) Filed: Aug. 9, 2005

(51) Int. Cl. B43K 29/00

(52) U.S. Cl. 401/195

(57) ABSTRACT

A promotional writing instrument includes an elongated barrel having a writing end and first and second longitudinally adjacent transparent chambers. Translucent fluid substantially fills the first and second chambers, and a first object is disposed within the first chamber and a second object is disposed within the second chamber. Movement of the first and second objects is viewable through the transparent first and second chambers. A portion of the barrel between the first and second chambers is substantially non-transparent and blocks from view adjacent respective portions of the first and second chambers. When the first object moves downwardly through the fluid in the first chamber, the first object disappears behind the barrel non-transparent portion substantially at the same time as the second object appears from behind the barrel non-transparent portion as the second object moves downwardly through the fluid in the second chamber.

### FIELD OF THE INVENTION

The present invention relates generally to product and service promotion and, more particularly, to the promotion of healthcare-related products and services.

### BACKGROUND OF THE INVENTION

The use of promotional items has proliferated in today's increasingly competitive marketplace, where companies are constantly seeking more effective and new ways to market their products. In the healthcare industry, physicians and other healthcare providers often receive promotional articles from vendors of healthcare-related products, such as pharmaceutical products. These promotional articles often include “everyday” items, such as writing pads, calendars, and pens that have promotional information (indicia) printed thereon. For example, pharmaceutical companies often provide physicians with writing pens having the name of a particular pharmaceutical product printed thereon with the hopes that the pens will help remind the physicians to prescribe the particular pharmaceutical product.

Unfortunately, because of lack of distinctiveness, many promotional articles provided to healthcare providers often become “lost-in-the-shuffle” with other promotional articles. Thus, there is a need for distinctive, more effective promotional products directed to healthcare providers as well as to others.

### SUMMARY OF THE INVENTION

In view of the above discussion, a promotional writing instrument is provided that includes an elongated barrel having a writing end and having first and second longitudinally adjacent transparent chambers. Translucent fluid substantially fills the first and second chambers. A first object is disposed within the first chamber and a second object is disposed within the second chamber. The first and second objects are configured to move through the translucent fluid in the same longitudinal direction when the writing instrument is inverted relative to horizontal. Movement of the first and second objects is viewable through the transparent first and second chambers.

According to embodiments of the present invention, a portion of the barrel between the first and second chambers is substantially non-transparent and blocks from view adjacent respective portions of the first and second chambers. When the first object moves downwardly through the fluid in the first chamber, the first object disappears behind the non-transparent portion of the barrel substantially at the same time as the second object appears from behind the non-transparent portion of the barrel as the second object moves downwardly through the fluid in the second chamber. Thus, the non-transparent portion is configured such that only one of the first and second objects is viewable at a time.

According to embodiments of the present invention, the second object is a reduced scale replica of the first object. For example, the first and second objects may be replicas of a human prostate gland. The first object represents an enlarged human prostate gland before medical treatment and the second object represents the human prostate gland after medical treatment. Thus, as the second object appears from behind the non-transparent portion, it represents the first object after medical treatment.

According to other embodiments of the present invention, a writing instrument includes elongated first and second barrel portions. The first barrel portion has a first end and a second end. The second barrel portion is hollow and transparent, and includes opposite third and fourth ends. When assembled, the third end of the second barrel portion is secured to the second end of the first barrel portion. A partition is positioned within the second barrel portion and divides the second barrel portion into first and second longitudinally adjacent transparent chambers. A translucent fluid substantially fills the first and second chambers.

A first object is disposed within the first chamber, and a second object is disposed within the second chamber. The first and second objects are configured to move through the translucent fluid in the same longitudinal direction when the writing instrument is inverted relative to horizontal (i.e., when the second barrel portion fourth end is oriented generally upward or oriented generally downward). Movement of the first and second objects is viewable through the respective first and second chambers because of the transparency of the second barrel portion and because of the translucency of the fluid.

An annular panel is attached to the second barrel portion and is configured to block from view respective portions of the first and second chambers adjacent the partition. Upon inverting the writing instrument such that the second barrel fourth end is pointing upwardly, the first and second objects move downwardly through the translucent fluid in the respective first and second chambers. The first object moves downwardly through the fluid in the first chamber and disappears behind the annular panel substantially at the same time as the second object appears from behind the annular panel as the second object moves downwardly through the fluid in the second chamber. Thus, the annular panel is configured such that only one of the first and second objects is viewable at a time.

According to other embodiments of the present invention, a writing instrument includes an elongated barrel having a writing end and comprising first and second longitudinally adjacent transparent chambers. A portion of the barrel between the first and second chambers is substantially non-transparent and blocks from view adjacent respective portions of the first and second chambers. Translucent fluid substantially fills the first and second chambers, and one or more objects are disposed within the first and second chambers. The one or more objects are configured to move through the translucent fluid in the same longitudinal direction when the writing instrument is inverted relative to horizontal, and movement of the one or more objects is viewable through the transparent first and second chambers.

According to other embodiments of the present invention, a writing instrument includes an elongated barrel having a writing end and comprising first, second and third longitudinally adjacent transparent chambers, wherein adjacent chambers are separated by partitions. Translucent fluid substantially fills the first, second and third chambers. A first object is disposed within the first chamber, a second object is disposed within the second chamber, and a third object is disposed within the third chamber. The first, second and third objects are configured to move through the translucent fluid in the same longitudinal direction when the writing instrument is inverted relative to horizontal. Movement of the first, second and third objects is viewable through the transparent first, second and third chambers. A first portion of the barrel between the first and second chambers is substantially non-transparent and blocks from view adjacent respective portions of the first and second chambers such that, when the first object moves downwardly through the fluid in the first chamber, the first object disappears behind the first barrel non-transparent portion substantially at the same time as the second object appears from behind the first barrel non-transparent portion as the second object moves downwardly through the fluid in the second chamber. A second portion of the barrel between the second and third chambers is substantially non-transparent and blocks from view adjacent respective portions of the second and third chambers such that, when the second object moves downwardly through the fluid in the second chamber, the second object disappears behind the second barrel non-transparent portion substantially at the same time as the third object appears from behind the second barrel non-transparent portion as the third object moves downwardly through the fluid in the third chamber.

### BRIEF DESCRIPTION OF THE DRAWINGS

FIGS. 1-3 are perspective views of a writing instrument, according to embodiments of the present invention, that illustrate movement of first and second objects through translucent fluid in respective first and second chambers.

FIG. 4 is a cross-sectional view of the writing instrument of FIG. 3 taken along lines 4-4 and illustrating a partition that separates the first and second chambers, according to an embodiment of the present invention.

FIG. 5 is a cross-sectional view of the writing instrument of FIG. 1 illustrating a partition that separates the first and second chambers, according to another embodiment of the present invention.

FIG. 6A is perspective view of a writing instrument, according to embodiments of the present invention, that illustrate movement of first and second connected objects through translucent fluid within the barrel of the writing instrument.

FIGS. 6B and 6C are cross-sectional views of the writing instrument of FIG. 6A that illustrate movement of the connected first and second objects.

FIGS. 7A-7C are perspective views of a writing instrument, according to embodiments of the present invention, that illustrate movement of first and second objects through translucent fluid in respective first and second chambers, and wherein the second object is a transformation of the first object.

FIGS. 8A-8C are perspective views of a writing instrument, according to embodiments of the present invention, that illustrate movement of a plurality of first objects and a second object through translucent fluid in respective first and second chambers, and wherein the second object is a transformation of the plurality of first objects.

FIGS. 9A-9C are perspective views of a writing instrument, according to embodiments of the present invention, that illustrate movement of a plurality of first objects and a second object through translucent fluid in respective first and second chambers, and wherein the second object is a transformation of the plurality of first objects.

FIGS. 10A-10C are perspective views of a writing instrument, according to embodiments of the present invention, that illustrate movement of first, second and third objects through translucent fluid in respective first, second and third chambers.

FIGS. 11A-11C are perspective views of a writing instrument, according to embodiments of the present invention, that illustrate movement of first, second and third objects through translucent fluid in respective first, second and third chambers.

FIGS. 12A-12C are perspective views of a writing instrument, according to embodiments of the present invention, that illustrate movement of first, second and third objects through translucent fluid in respective first, second and third chambers.

FIGS. 13A-13C are perspective views of a writing instrument, according to embodiments of the present invention, that illustrate movement of a plurality of objects through translucent fluid in respective first and second chambers.

FIGS. 14A-14C are perspective views of a writing instrument, according to embodiments of the present invention, that illustrate movement of a plurality of a first object and a second object through translucent fluid in respective first and second chambers.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity. Broken lines illustrate optional features or operations unless specified otherwise. All publications, patent applications, patents, and other references mentioned herein are incorporated herein by reference in their entireties.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached” to, “connected” to, “coupled” with, “contacting”, etc., another element, it can be directly on, attached to, connected to, coupled with or contacting the other element or intervening elements may also be present. In contrast, when an element is referred to as being, for example, “directly on”, “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a “first” element, component, region, layer or section discussed below could also be termed a “second” element, component, region, layer or section without departing from the teachings of the present invention. The sequence of operations (or steps) is not limited to the order presented in the claims or figures unless specifically indicated otherwise.

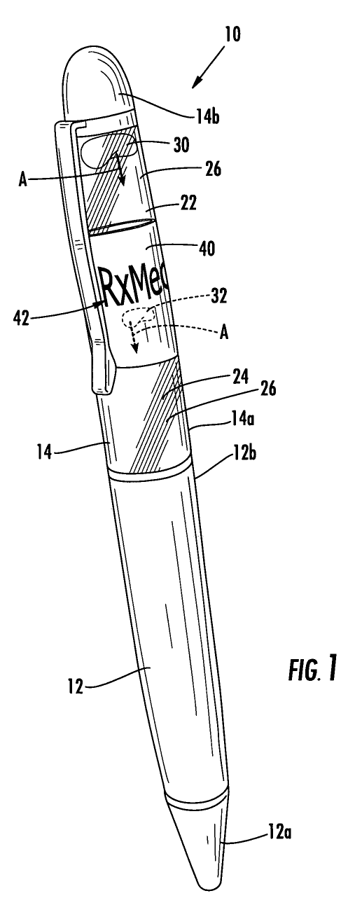

Referring now to FIG. 1, a writing instrument 10 according to an embodiment of the present invention is illustrated. The illustrated writing instrument 10 includes elongated first and second barrel portions 12, 14. The first barrel portion 12 has a first end 12a and a second end 12b. As would be understood by those of skill in the art, a writing element (not shown) is extended and retracted through the first end 12a. Various types of writing elements (e.g., flair-tip writing elements, ball-point writing elements, etc.) may be utilized in accordance with embodiments of the present invention. Writing elements are well known to those of skill in the art, and will not be further described herein. Embodiments of the present invention are not limited to a particular style of writing instrument or to a particular type of writing element.

The illustrated first and second barrel portions 12, 14 have generally cylindrical configurations. However, writing instruments according to embodiments of the present invention may have barrel portions with various other shapes and configurations, without limitation.

The second barrel portion 14 is hollow and transparent, and includes opposite third and fourth ends 14a, 14b. The transparent second barrel portion 14 may be formed from various transparent materials including, but not limited to, thermosetting polymers, thermoplastic polymers, glass, etc.

When assembled, the third end 14a of the second barrel portion 14 is secured to the second end 12b of the first barrel portion 12. The first and second barrel portions 12, 14 may be secured together in various ways, without limitation. For example, the third end 14a of the second barrel portion 14 may be adhesively secured within the second end 12b of the first barrel portion 12; the third end 14a of the second barrel portion 14 may be threadingly secured within the second end 12b of the first barrel portion 12; or the third end 14a of the second barrel portion 14 may be press-fit within the second end 12b of the first barrel portion 12.

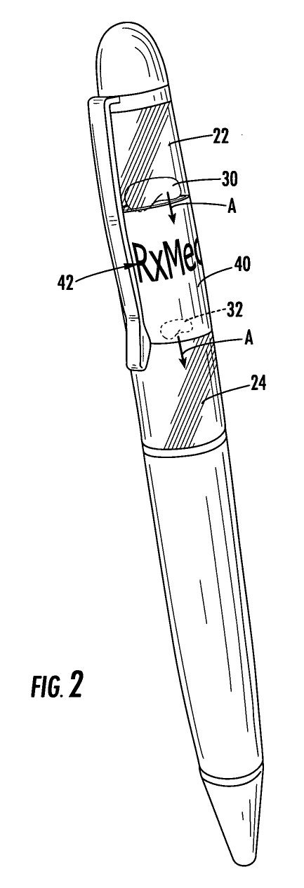

In the illustrated embodiment, a partition 20 (FIG. 4) is positioned within the second barrel portion 14 and divides the second barrel portion 14 into first and second longitudinally adjacent transparent chambers 22, 24. However, according to other embodiments of the present invention, the partition 20 may be integrally formed with the second barrel portion 14 and need not be a separate element.

A translucent fluid 26 substantially fills the first and second chambers 22, 24. Exemplary translucent fluids which may be utilized include, but are not limited to, water, glycerin, mineral oil, etc. Preferably, a non-toxic, environmentally-neutral fluid is utilized for the fluid 26. According to embodiments of the present invention, the fluid 16 may have color as long as the objects therewithin can be viewed externally, as described below.

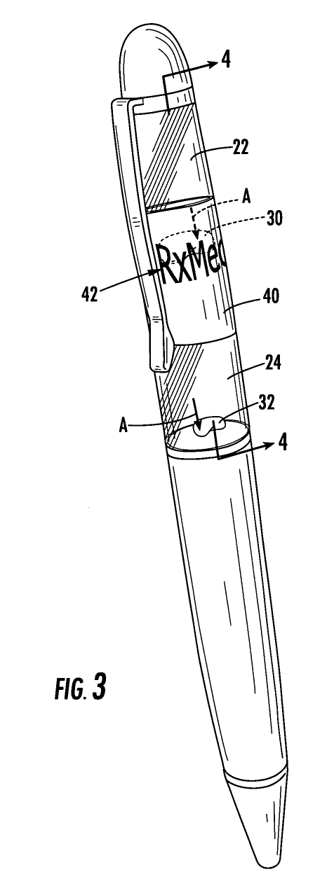

The partition 20 illustrated in FIG. 4 is solid and does not permit the fluid 26 to move between the first and second chambers 22, 24. According to another embodiment of the present invention illustrated in FIG. 5, the partition 20′ contains apertures 21 that permit the translucent fluid 26 to pass between the first and second chambers 22, 24.

A first object 30 is disposed within the first chamber 22, and a second object 32 disposed within the second chamber 24, as illustrated. The first and second objects 30, 32 are configured to move through the translucent fluid 26 in the same longitudinal direction (indicated by arrows A) when the writing instrument 10 is inverted relative to horizontal (i.e., when the second barrel portion fourth end 14b is oriented generally upward or oriented generally downward. Movement of the first and second objects 30, 32 is viewable through the respective first and second chambers because of the transparency of the second barrel portion 14 and because of the translucency of the fluid 26.

In the illustrated embodiment, an annular panel 40 (e.g., a label) is attached to the outer surface 15 of the second barrel portion 14 and contains promotional indicia 42 disposed thereon. The promotional indicia 42 may be for virtually any product or service and is preferably for a medical product/service. Various types of promotional indicia including, but not limited to, lettering, designs, characters, logos and other symbols, may be utilized in accordance with embodiments of the present invention. The term “lettering” as used herein includes, but is not limited to, alphabetical characters and alphanumeric characters.

The annular panel 40 is configured to block from view respective portions of the first and second chambers 22, 24 adjacent the partition 20. Upon inverting the writing instrument 10 such that the second barrel fourth end 14b is pointing upwardly, the first and second objects 30, 32 move downwardly through the translucent fluid 26 in the respective first and second chambers 22, 24. The first object 30 moves downwardly through the fluid 26 in the first chamber 22 and disappears behind the annular panel 40 substantially at the same time as the second object 32 appears from behind the annular panel 40 as the second object 32 moves downwardly through the fluid 26 in the second chamber 24. Thus, the annular panel 40 is configured such that only one of the first and second objects 30, 32 is viewable at a time. Stated another way, the annular panel 40 blocks from view the first object 30 when the first object 30 is in contacting relationship with the partition 20, and blocks from view the second object 32 when the second object 32 is in contacting relationship with the partition 20.

FIGS. 1-3 illustrate the progression of the first and second objects 30, 32 as they move downwardly within the respective first and second chambers 22, 24. In FIG. 1, the writing instrument 10 has just been inverted such that the second barrel fourth end 14b is oriented generally upward and the first and second objects 30, 32 are beginning their downward ascent through the respective first and second chambers 22, 24. In FIG. 2, the first object 30 is just about to become hidden from view behind the annular panel 40 and the second object 32 is just about to come into view from behind the annular panel 40. In FIG. 3, the first and second objects 30, 32 have finished their respective journeys downwards through the first and second chambers 22, 24. The second object 32 is visible and the first object 30 is not visible.

According to other embodiments of the present invention, the annular panel 40 may be attached to an inner surface of the second barrel portion 14. Alternatively, the second barrel portion 14 may have a substantially non-transparent portion that serves the function of the annular panel 40 and that blocks from view respective portions of the first and second chambers 22, 24 adjacent the partition 20. This non-transparent portion may contain promotional indicia.

In the illustrated embodiment, the second object 32 is a reduced scale replica of the first object 30. Specifically, the first and second objects in the illustrated embodiment are replicas of a human prostate gland. The first object 30 represents an enlarged human prostate gland before medical treatment and the second object 32 represents the human prostate gland after medical treatment. According to an embodiment of the present invention, the promotional indicia 42 on the annular panel 40 relates to the medical treatment applied to the human prostate gland.

According to embodiments of the present invention, the first and second objects 30, 32 may be replicas of any type of biological object of a subject including, but not limited to, organs, glands, bones, muscles, ligaments, tissue, etc. The first object 30, thus, represents the biological object before medical treatment and the second object 32 represents the biological object after medical treatment.

According to embodiments of the present invention, the first and second objects 30, 32 may be replicas of any type of object or may be the actual objects, themselves. Exemplary first and second objects 30, 32 Include, but are not limited to, replicas of vehicles, electronic components, molecules, drug delivery devices, pharmaceuticals, biological objects, medical devices, etc.

Embodiments of the present invention are not limited to the configuration and size of the illustrated first and second objects 30, 32. Objects 30, 32 may have any size, color, shape and the like depending on the overall appearance desired. In addition, various numbers of objects 30, 32 may be utilized.

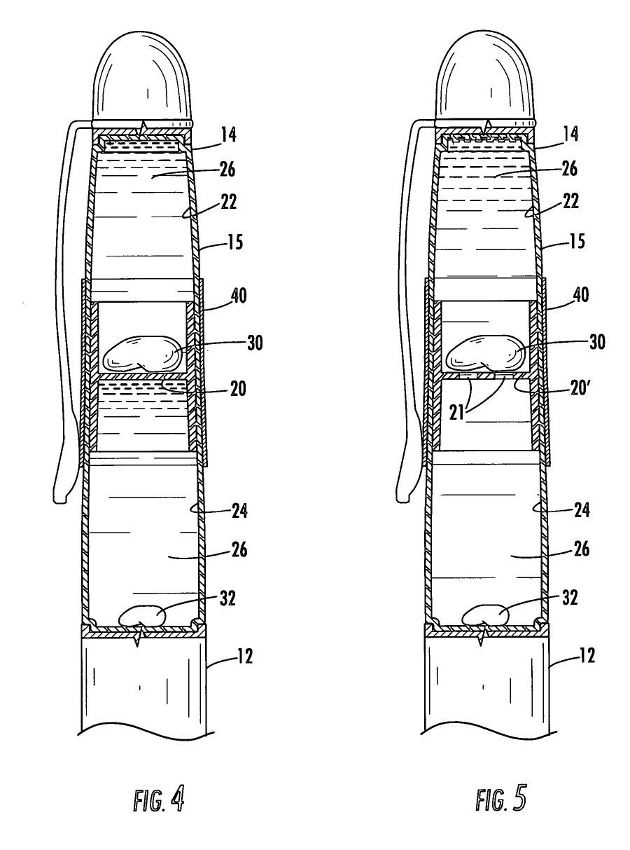

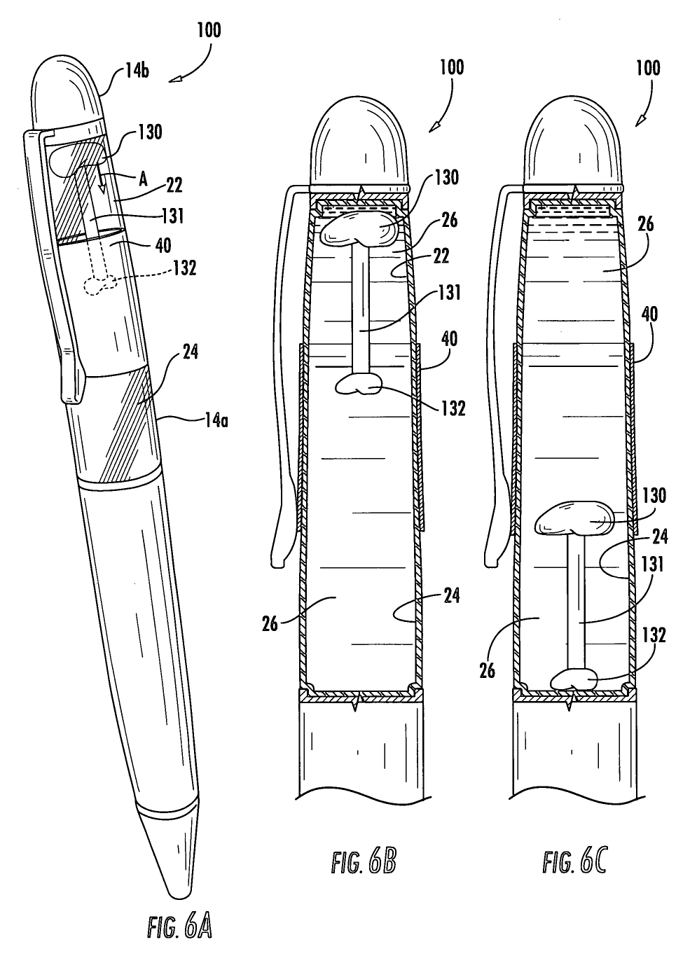

According to another embodiment of the present invention illustrated in FIGS. 6A-6C, a writing instrument 100 includes first and second objects 130,132 that are connected together via connector rod 131 and that move in unison through translucent fluid 26 within the barrel of the writing instrument 100 when the writing instrument 100 is inverted relative to horizontal, as described above (i.e., when the second barrel portion fourth end 14b is oriented generally upward or oriented generally downward. Movement of the first and second objects 130, 132 is viewable through the respective first and second chambers 22, 24 because of the transparency of the second barrel portion 14 and because of the translucency of the fluid 26.

FIGS. 6A-6C illustrate the progression of the first and second objects 130, 132 as they move downwardly within the respective first and second chambers 22, 24. In FIGS. 6A-6B, the writing instrument 10 has just been inverted such that the second barrel fourth end 14b is oriented generally upward and the first and second objects 130, 132 are beginning their downward ascent through the respective first and second chambers 22, 24. The first object 130 is visible through the first chamber 22 and the second object 132 is hidden from view behind the annular panel 40. In FIG. 6C, the connected first and second objects 130, 132 have finished their journey downwards through the first and second chambers 22, 24. The second object 132 is visible and the first object 130 is not visible.

In the embodiment illustrated in FIGS. 6A-6C, the connector rod 131 is preferably translucent so as not easily viewable, although this is not required. The connector rod 131 is also of sufficient length such that only the first object 130 is viewable in the first chamber 22 and only the second object 132 is viewable in the second chamber 24.

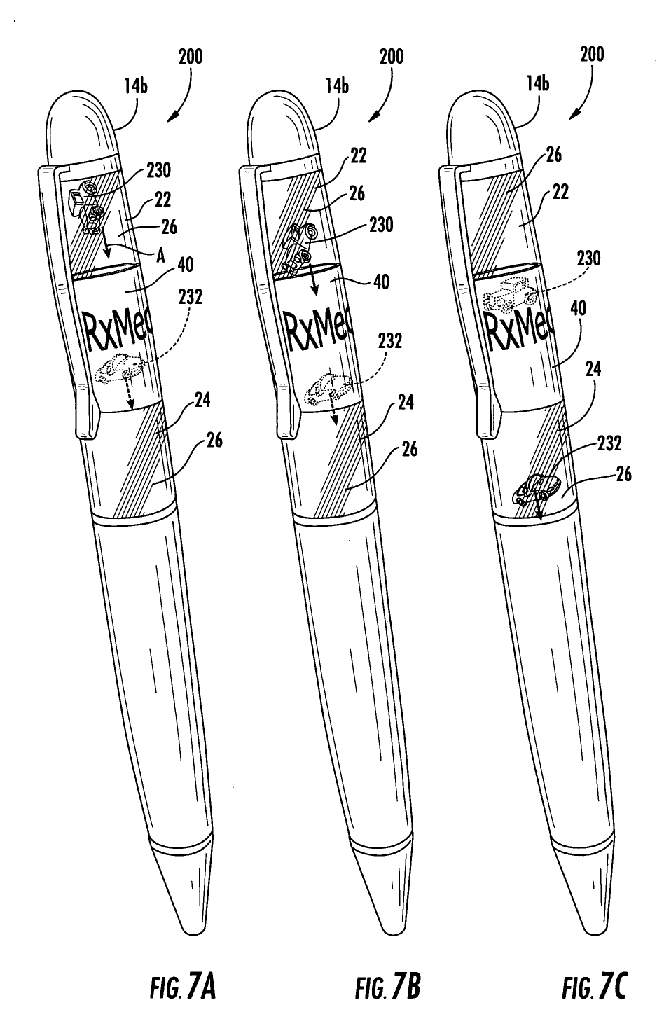

FIGS. 7A-7C, 8A-8C and 9A-9C illustrate respective writing instruments 200, 300 and 400, according to other embodiments of the present invention, wherein one or more first objects appear to transform into different second objects. Writing instruments 200, 300 and 400 have the same configuration as writing instrument 10 of FIGS. 1-5 wherein first 30 and second chambers 22, 24 contain translucent fluid 26 and are separated by a partition 20.

In FIGS. 7A-7C, the writing instrument 200 includes a first object 230 in the shape of an old car and a second object 232 in the shape of a modern sports car. In FIG. 7A, the writing instrument 200 has just been inverted such that the second barrel fourth end 14b is oriented generally upward and the first and second objects 230, 232 are beginning their downward ascent through the respective first and second chambers 22, 24. In FIG. 7B, the first object 230 is just about to become hidden from view behind the annular panel 40 and the second object 232 is just about to come into view from behind the annular panel 40. In FIG. 7C, the first and second objects 230, 232 have finished their respective journeys downwards through the first and second chambers 22, 24. The second object 232 is visible and the first object 230 is not visible. According to this embodiment, an old car appears to transform into a modern sports car.

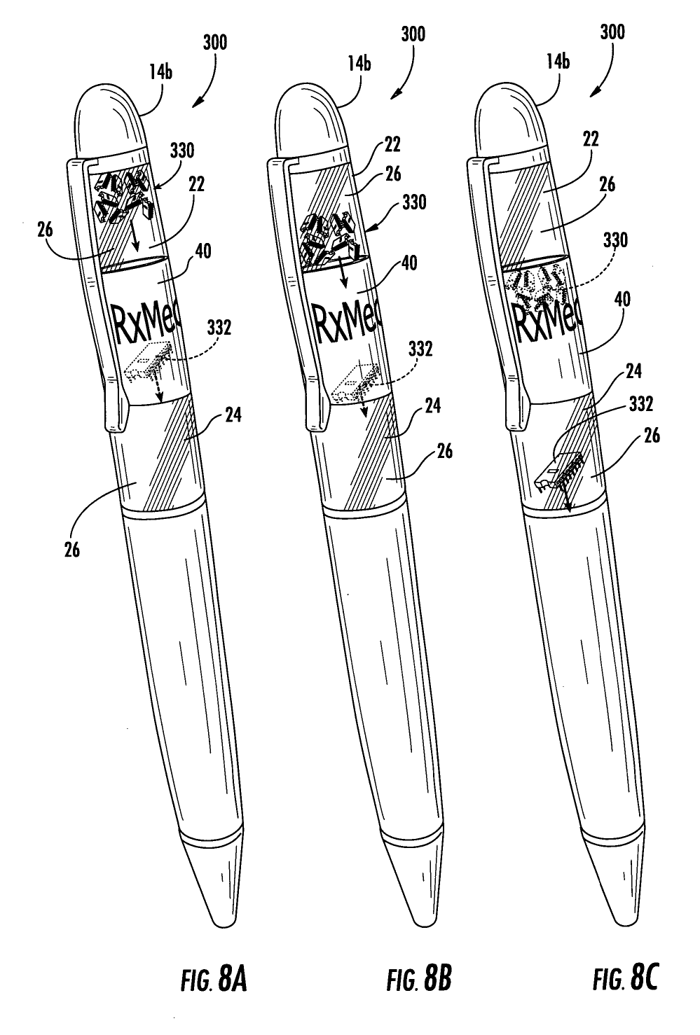

In FIGS. 8A-8C, the writing instrument 300 includes a plurality of first objects 330 in the shape of small integrated circuit (IC) chips and a second object 332 in the shape of a large IC chip. In FIG. 8A, the writing instrument 300 has just been inverted such that the second barrel fourth end 14b is oriented generally upward and the first and second objects 330, 332 are beginning their downward ascent through the respective first and second chambers 22, 24. In FIG. 8B, the first objects 330 are just about to become hidden from view behind the annular panel 40 and the second object 332 is just about to come into view from behind the annular panel 40. In FIG. 8C, the first and second objects 330, 332 have finished their respective journeys downwards through the first and second chambers 22, 24. The second object 332 is visible and the first objects 330 are not visible. According to this embodiment, small IC chips appears to transform into a single large IC chip.

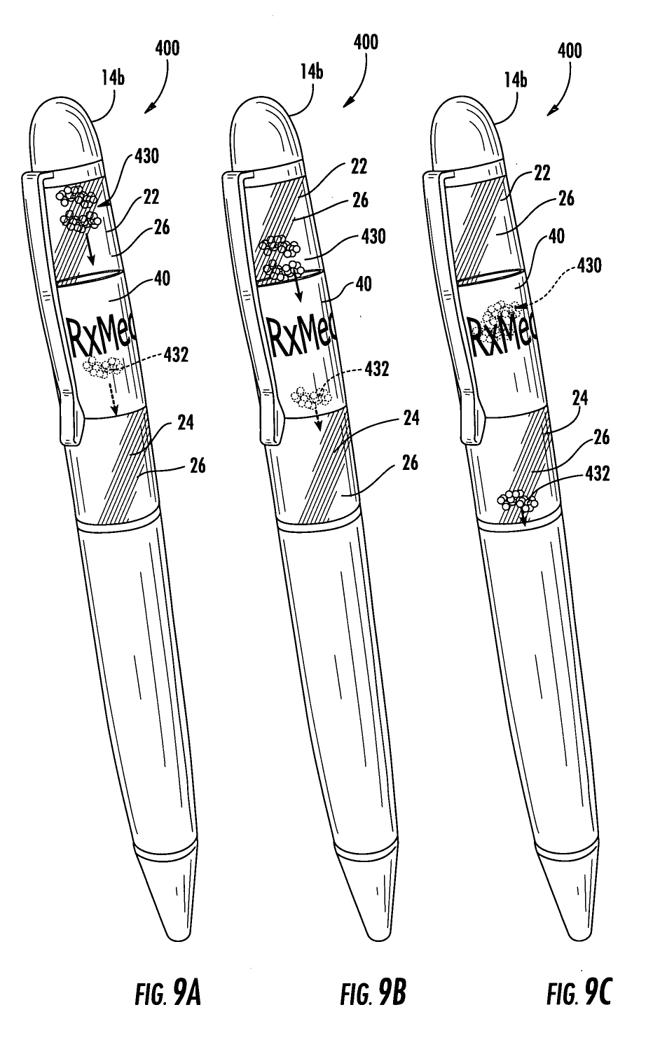

In FIGS. 9A-9C, the writing instrument 400 includes first objects 430 in the shape of two molecules and a second object 432 in the shape of a single molecule. In FIG. 9A, the writing instrument 400 has just been inverted such that the second barrel fourth end 14b is oriented generally upward and the first and second objects 430, 432 are beginning their downward ascent through the respective first and second chambers 22, 24. In FIG. 9B, the first objects 430 are just about to become hidden from view behind the annular panel 40 and the second object 432 is just about to come into view from behind the annular panel 40. In FIG. 9C, the first and second objects 430, 432 have finished their respective journeys downwards through the first and second chambers 22, 24. The second object 432 is visible and the first objects 430 are not visible. According to this embodiment, an two molecules appear to transform or join into a single molecule.

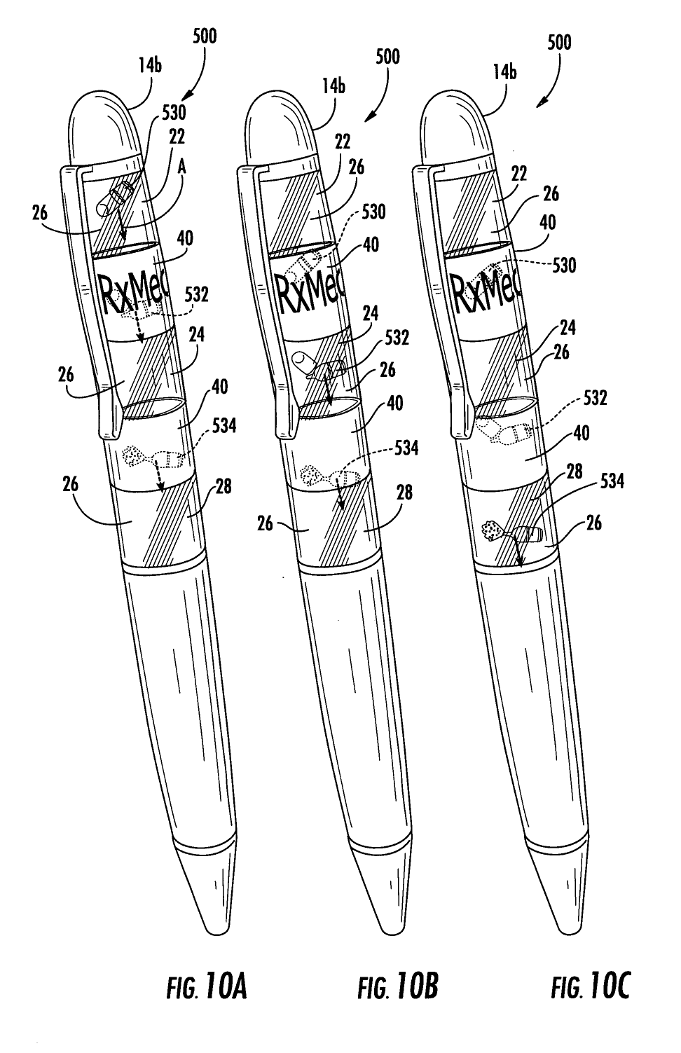

FIGS. 10A-10C, 11A-11C and 12A-12C illustrate respective writing instruments 500, 600 and 700, according to other embodiments of the present invention, wherein an object is shown in various stages of use in respective first, second and third chambers 22, 24, 28 of the respective writing instrument. Writing instruments 500, 600 and 700 have the same configuration as writing instrument 10 of FIGS. 1-5 with the addition of a third chamber 28, a partition between the second and third chambers 24, 28, and a second annular panel 40 positioned between the second and third chambers 24, 28. Thus, first, second and third chambers 22, 24, 28 contain translucent fluid 26 and are separated by respective partitions 20.

In FIGS. 10A-10C, the writing instrument 500 includes a first object 530 in the shape of an sprayer, a second object 532 in the shape of an sprayer with its top removed, and a third object 534 in the shape of an sprayer being used. The first object 530 is retained within the first chamber 22, the second object 532 is retained within the second chamber 24 and the third object 534 is retained within the third chamber 28. In FIG. 1A, the writing instrument 500 has just been inverted such that the second barrel fourth end 14b is oriented generally upward and the first, second and third objects 530, 532, 534 are beginning their downward ascent through the respective first, second and third chambers 22, 24, 28. The first object 530 is the only object visible at this stage. The second and third objects 532, 534 are hidden from view behind respective annular panels 40, as illustrated. In FIG. 10B, the first object 530 and third object 534 are hidden from view behind the respective annular panels 40, as illustrated, and the second object 532 is visible within the second chamber 24. In FIG. 10C, the first and second objects 530, 532 have finished their respective journeys downwards through the first and second chambers 22, 24 and are not visible, and the third object 534 is visible in the third chamber 28. According to this embodiment, a sprayer is shown in various stages of use. In the first chamber 22, a sprayer is shown. In the second chamber 24, the sprayer with its top off is shown. In the third chamber 28, the sprayer is being used.

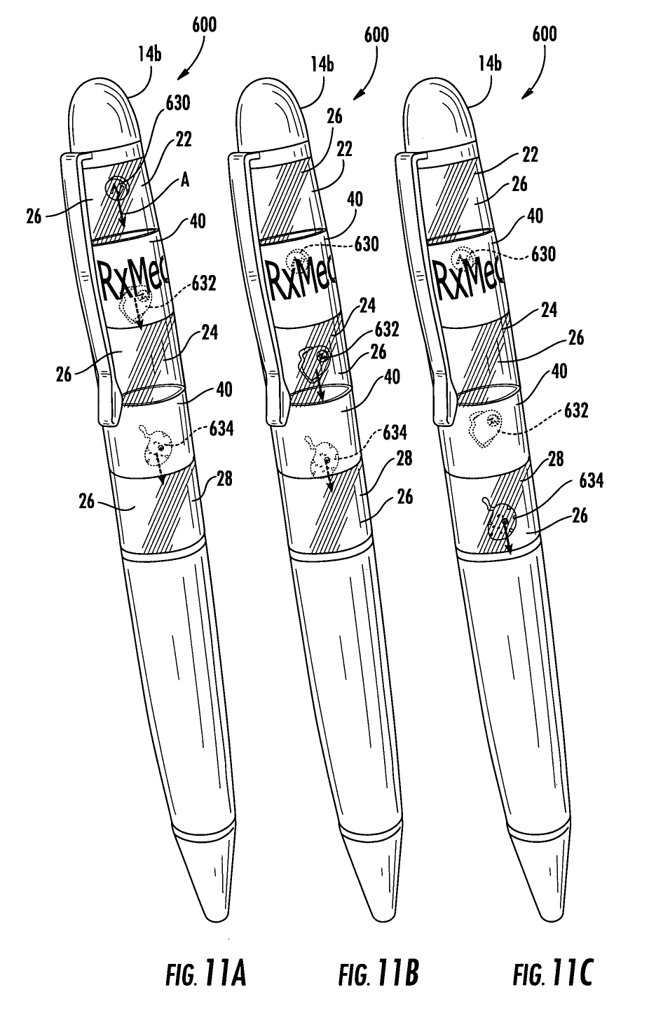

In FIGS. 11A-11C, the writing instrument 600 includes a first object 630 in the shape of a pill, a second object 632 in the shape of a pill on a user's tongue, and a third object 634 in the shape of a pill in a user's stomach. The first object 630 is retained within the first chamber 22, the second object 632 is retained within the second chamber 24 and the third object 634 is retained within the third chamber 28. In FIG. 11A, the writing instrument 600 has just been inverted such that the second barrel fourth end 14b is oriented generally upward and the first, second and third objects 630, 632, 634 are beginning their downward ascent through the respective first, second and third chambers 22, 24, 28. The first object 630 is the only object visible at this stage. The second and third objects 632, 634 are hidden from view behind respective annular panels 40, as illustrated. In FIG. 11B, the first object 630 and third object 634 are hidden from view behind the respective annular panels 40, as illustrated, and the second object 632 is visible within the second chamber 24. In FIG. 11C, the first and second objects 630, 632 have finished their respective journeys downwards through the first and second chambers 22, 24 and are not visible, and the third object 634 is visible in the third chamber 28. According to this embodiment, a pill is shown in various stages of use. In the first chamber 22, a pill is shown. In the second chamber 24, the pill is on a user's tongue. In the third chamber 28, the pill is in a user's stomach.

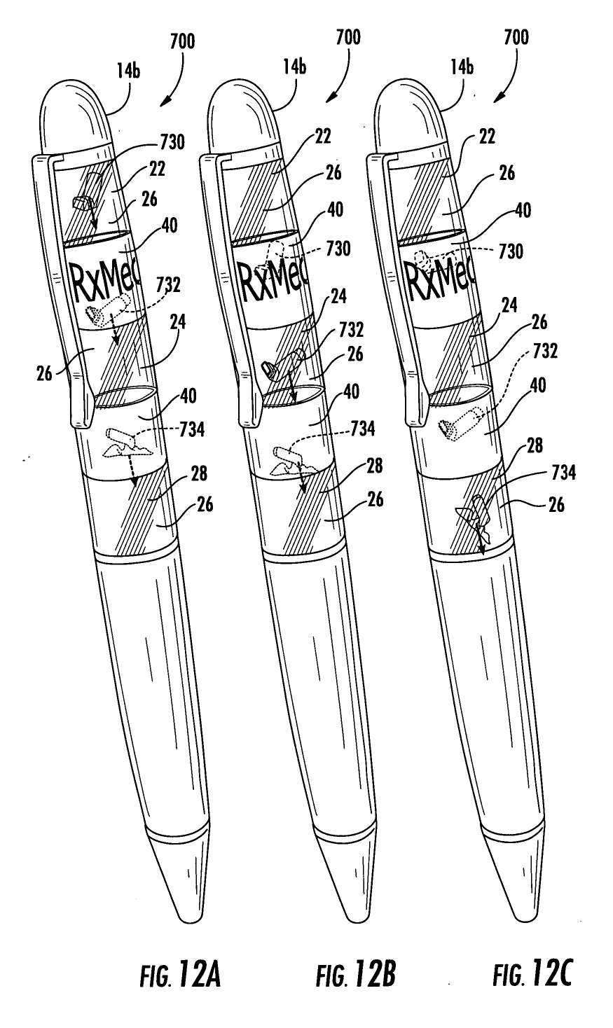

In FIGS. 12A-12C, the writing instrument 700 includes a first object 730 in the shape of an inhaler, a second object 732 in the shape of an inhaler with its top removed, and a third object 734 in the shape of an inhaler being used. The first object 730 is retained within the first chamber 22, the second object 732 is retained within the second chamber 24 and the third object 734 is retained within the third chamber 28. In FIG. 12A, the writing instrument 700 has just been inverted such that the second barrel fourth end 14b is oriented generally upward and the first, second and third objects 730, 732, 734 are beginning their downward ascent through the respective first, second and third chambers 22, 24, 28. The first object 730 is the only object visible at this stage. The second and third objects 732, 734 are hidden from view behind respective annular panels 40, as illustrated. In FIG. 12B, the first object 730 and third object 734 are hidden from view behind the respective annular panels 40, as illustrated, and the second object 732 is visible within the second chamber 24. In FIG. 12C, the first and second objects 730, 732 have finished their respective journeys downwards through the first and second chambers 22, 24 and are not visible, and the third object 734 is visible in the third chamber 28. According to this embodiment, an inhaler is shown in various stages of use. In the first chamber 22, an inhaler is shown. In the second chamber 24, the inhaler with its top off is shown. In the third chamber 28, the inhaler is being used.

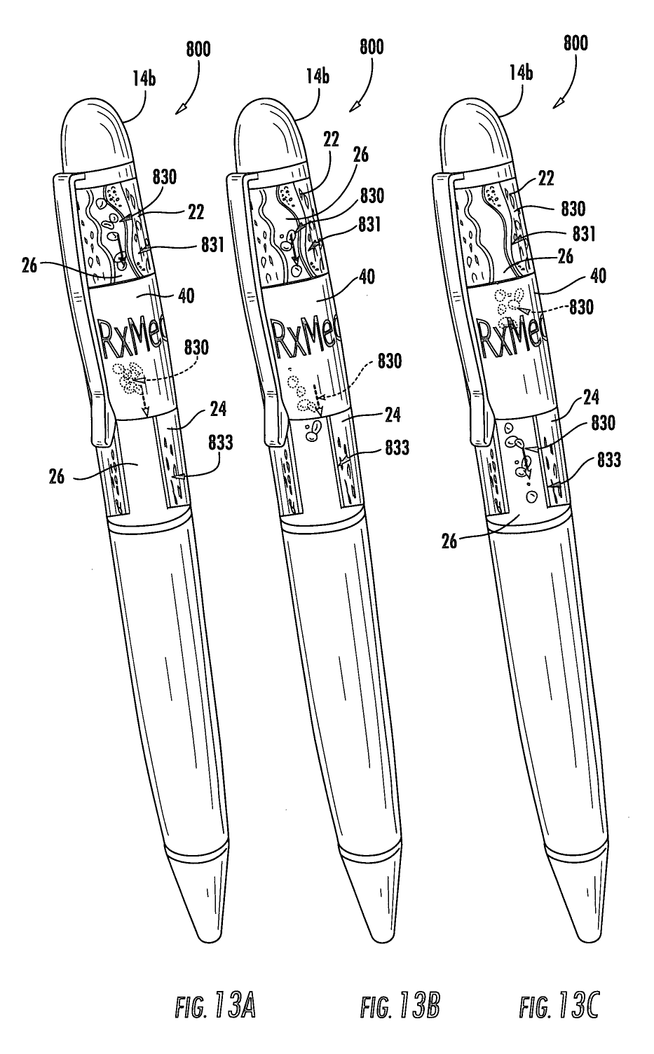

According to another embodiment of the present invention illustrated in FIGS. 13A-13C, a writing instrument 800 includes first and second chambers 22, 24 containing translucent fluid 26. The first and second chambers 22, 24 are not separated by a partition and objects can move from the first chamber 22 into the second chamber 24. In the illustrated embodiment, the first chamber 22 has the appearance of an occluded blood vessel and the second chamber 24 has the appearance of a healthy, non-occluded blood vessel. Objects 830 are configured to pass from the first chamber 22 into the second chamber 24 when the writing instrument 800 is inverted relative to horizontal, as described above (i.e., when the second barrel portion fourth end 14b is oriented generally upward or oriented generally downward. Movement of the objects 830 is viewable through the respective first and second chambers 22, 24 because of the transparency of the second barrel portion 14 and because of the translucency of the fluid 26.

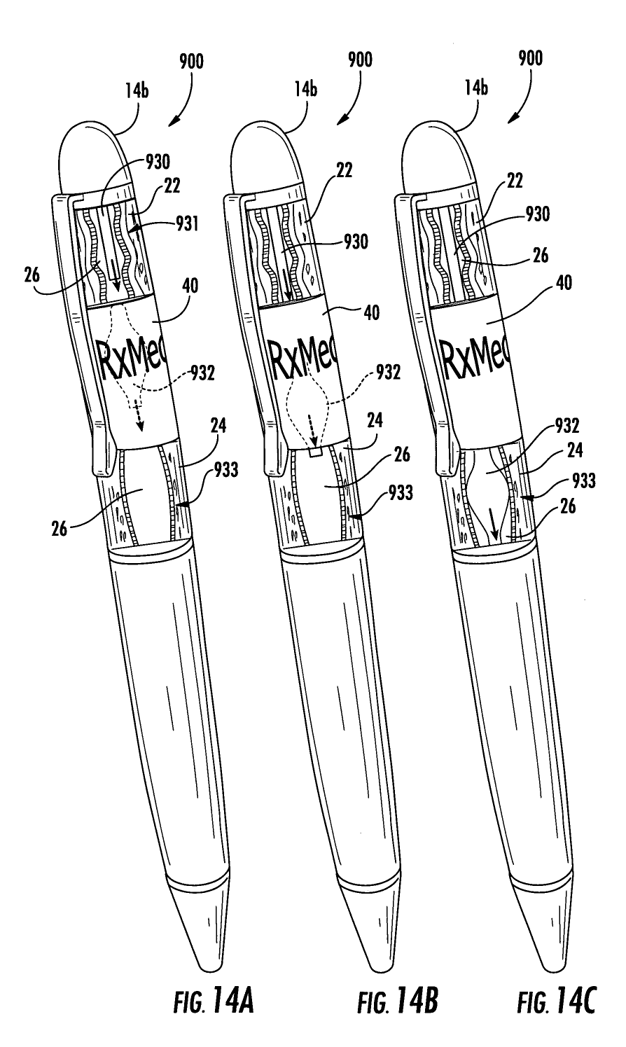

According to another embodiment of the present invention illustrated in FIGS. 14A-14C, a writing instrument 900 includes first and second chambers 22, 24 containing translucent fluid 26. The writing instrument 900 has the same configuration as writing instrument 10 of FIGS. 1-5 wherein first and second chambers 22, 24 contain translucent fluid 26 and are separated by a partition 20. In the illustrated embodiment, the first chamber 22 has the appearance of an occluded blood vessel and the second chamber 24 has the appearance of a healthy, non-occluded blood vessel. A first object 930 in the shape of an unexpanded intraluminal prosthesis is within the first chamber 22 and a second object 932 in the shape of an expanded intraluminal prosthesis is within the second chamber 24.

In FIG. 14A, the writing instrument 900 has just been inverted such that the second barrel fourth end 14b is oriented generally upward and the first and second objects 930, 932 are beginning their downward ascent through the respective first and second chambers 22, 24. In FIG. 14B, the first object 930 has extended all the way down through the first chamber 22 and the second object 932 is just about to come into view from behind the annular panel 40. In FIG. 14C, the first and second objects 930, 932 have finished their respective journeys downwards through the first and second chambers 22, 24. The first and second objects 930, 932 are both visible, as illustrated. According to this embodiment, an unexpanded intraluminal prosthesis appears to transform an occluded, unhealthy blood vessel into a healthy, non-occluded blood vessel.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. The invention is defined by the following claims, with equivalents of the claims to be included therein.

That which is claimed is:

1. A writing instrument, comprising:
an elongated barrel having a writing end and comprising first and second longitudinally adjacent transparent chambers;
translucent fluid substantially filling the first and second chambers;
a first object disposed within the first chamber; and
a second object disposed within the second chamber;
wherein the first and second objects are configured to move through the translucent fluid in the same longitudinal direction when the writing instrument is inverted relative to horizontal, and wherein movement of the first and second objects is viewable through the transparent first and second chambers.

2. The writing instrument of claim 1, wherein a portion of the barrel between the first and second chambers is substantially non-transparent and blocks from view adjacent respective portions of the first and second chambers such that, when the first object moves downwardly through the fluid in the first chamber, the first object disappears behind the barrel non-transparent portion substantially at the same time as the second object appears from behind the barrel non-transparent portion as the second object moves downwardly through the fluid in the second chamber.

3. The writing instrument of claim 1, wherein the second object is a reduced scale replica of the first object.

4. The writing instrument of claim 1, wherein the first and second objects are connected so as to move in unison.

5. The writing instrument of claim 3, wherein the first and second objects are replicas of a respective biological object of a subject, and wherein the first object represents the biological object before medical treatment and the second object represents the biological object after medical treatment, and wherein the biological object is selected from the group consisting of organs, glands, bones, muscles, ligaments, tissue, etc.

6. The writing instrument of claim 3, wherein the first and second objects are replicas of a human prostate gland.

7. The writing instrument of claim 1, wherein the first and second objects are replicas of objects selected from the group consisting of vehicles, electronic components, molecules, drug delivery devices, pharmaceuticals, biological objects and medical devices.

8. The writing instrument of claim 2, wherein the barrel non-transparent portion comprises promotional indicia disposed thereon.

9. A writing instrument, comprising:
an elongated barrel having a writing end and comprising first and second longitudinally adjacent transparent chambers, wherein a portion of the barrel between the first and second chambers is substantially non-transparent and blocks from view adjacent respective portions of the first and second chambers;
translucent fluid substantially filling the first and second chambers;
a first object disposed within the first chamber; and
a second object disposed within the second chamber, wherein the second object is a reduced scale replica of the first object;
wherein the first and second objects are configured to move through the translucent fluid in the same longitudinal direction when the writing instrument is inverted relative to horizontal, wherein movement of the first and second objects is viewable through the transparent first and second chambers, and wherein, when the first object moves downwardly through the fluid in the first chamber, the first object disappears behind the barrel non-transparent portion substantially at the same time as the second object appears from behind the barrel non-transparent portion as the second object moves downwardly through the fluid in the second chamber.

10. The writing instrument of claim 9, wherein the first and second objects are replicas of a respective biological object of a subject, and wherein the first object represents the biological object before treatment and the second object represents the biological object after treatment, and wherein the biological object is selected from the group consisting of organs, glands, bones, muscles, ligaments, tissue, etc.

11. The writing instrument of claim 10, wherein the first and second objects are replicas of a human prostate gland.

12. The writing instrument of claim 9, wherein the first and second objects are replicas of objects selected from the group consisting of vehicles, electronic components, molecules, drug delivery devices, pharmaceuticals, biological objects and medical devices.

13. The writing instrument of claim 9, wherein the barrel non-transparent portion comprises promotional indicia disposed thereon.

14. A writing instrument, comprising:
an elongated first barrel portion that comprises an open first end through which a writing element is extendable, and an opposite second end;
a transparent, hollow second barrel portion that comprises opposite third and fourth ends, wherein the third end is secured to the second end of the first barrel portion;
a partition positioned within the second barrel portion that divides the second barrel portion into first and second longitudinally adjacent transparent chambers;
translucent fluid substantially filling the first and second chambers;
a first object disposed within the first chamber; and
a second object disposed within the second chamber;
wherein the first and second objects are configured to move through the translucent fluid in the same longitudinal direction when the writing instrument is inverted relative to horizontal, and wherein movement of the first and second objects is viewable through the respective first and second chambers.

15. The writing instrument of claim 14, wherein the second object is a reduced scale replica of the first object.

16. The writing instrument of claim 14, further comprising an annular panel attached to the second barrel portion that blocks from view respective portions of the first and second chambers adjacent the partition.

17. The writing instrument of claim 16, wherein, upon inverting the writing instrument such that the second barrel fourth end is pointing upwardly, the first and second objects move downwardly through the translucent fluid in the respective first and second chambers, and wherein the first object moves downwardly through the fluid in the first chamber and disappears behind the annular panel substantially at the same time as the second object appears from behind the annular panel as the second object moves downwardly through the fluid in the second chamber.

18. The writing instrument of claim 16, wherein the annular panel blocks from view the first object when the first object is in contacting relationship with the partition, and wherein the annular panel blocks from view the second object when the second object is in contacting relationship with the partition.

19. The writing instrument of claim 16, wherein the annular panel is attached to an inner surface of the second barrel portion.

20. The writing instrument of claim 16, wherein the annular panel is attached to an outer surface of the second barrel portion.

21. The writing instrument of claim 16, wherein the annular panel comprises promotional indicia disposed thereon.

22. The writing instrument of claim 15, wherein the first and second objects are replicas of a respective biological object of a subject, and wherein the first object represents the biological object before medical treatment and the second object represents the biological object after medical treatment, and wherein the biological object is selected from the group consisting of organs, glands, bones, muscles, ligaments, tissue, etc.

23. The writing instrument of claim 14, wherein the first and second objects are replicas of a human prostate gland.

24. The writing instrument of claim 14, wherein the first and second objects are replicas of objects selected from the group consisting of vehicles, electronic components, molecules, drug delivery devices, pharmaceuticals, biological objects and medical devices.

25. The writing instrument of claim 14, wherein the partition comprises an aperture that permits the translucent fluid to flow therethrough.

26. A writing instrument, comprising:
an elongated barrel having a writing end and comprising first and second longitudinally adjacent transparent chambers, wherein a portion of the barrel between the first and second chambers is substantially non-transparent and blocks from view adjacent respective portions of the first and second chambers;
translucent fluid substantially filling the first and second chambers; and
one or more objects disposed within the first and second chambers, wherein the one or more objects are configured to move through the translucent fluid in the same longitudinal direction when the writing instrument is inverted relative to horizontal, and wherein movement of the one or more objects is viewable through the transparent first and second chambers.

27. A writing instrument, comprising:
an elongated barrel having a writing end and comprising first, second and third longitudinally adjacent transparent chambers;
translucent fluid substantially filling the first, second and third chambers;
a first object disposed within the first chamber;
a second object disposed within the second chamber; and
a third object disposed within the third chamber;
wherein the first, second and third objects are configured to move through the translucent fluid in the same longitudinal direction when the writing instrument is inverted relative to horizontal, and wherein movement of the first, second and third objects is viewable through the transparent first, second and third chambers.

28. The writing instrument of claim 27:
wherein a first portion of the barrel between the first and second chambers is substantially non-transparent and blocks from view adjacent respective portions of the first and second chambers such that, when the first object moves downwardly through the fluid in the first chamber, the first object disappears behind the first barrel non-transparent portion substantially at the same time as the second object appears from behind the first barrel non-transparent portion as the second object moves downwardly through the fluid in the second chamber; and
wherein a second portion of the barrel between the second and third chambers is substantially non-transparent and blocks from view adjacent respective portions of the second and third chambers such that, when the second object moves downwardly through the fluid in the second chamber, the second object disappears behind the second barrel non-transparent portion substantially at the same time as the third object appears from behind the second barrel non-transparent portion as the third object moves downwardly through the fluid in the third chamber.

29. The writing instrument of claim 27, wherein the first, second and third objects are replicas of objects selected from the group consisting of vehicles, electronic components, molecules, drug delivery devices, pharmaceuticals, biological objects and medical devices.
